(19) United States
(12) Patent Application Publication
(10) Pub. No.: US 2011/0069023 A1
(43) Pub. Date: Mar. 24, 2011

(54) APPARATUS AND METHOD FOR RECOGNIZING TOUCH USING RF SIGNAL

(75) Inventor: Dong-Hoon KWAK, Suwon-si (KR)

(73) Assignee: SAMSUNG ELECTRONICS CO. LTD., Suwon-si (KR)

(21) Appl. No.: 12/851,806

(22) Filed: Aug. 6, 2010

(30) Foreign Application Priority Data
Sep. 22, 2009 (KR) 10-2009-0089411

(51) Int. Cl. G06F 3/041

(52) U.S. Cl. 345/173

(57) ABSTRACT

An apparatus and a method for recognizing a touch using a Radio Frequency (RF) signal are provided. The apparatus includes an RF signal generator and a data processor. When one point is pressed on a touch panel, the RF signal generator generates at least one RF signal corresponding to the one point. The data processor detects at least one of an amplitude and a phase of each frequency component from the at least one RF signal, and determines a touched position using the detected at least one of the amplitude and the phase information of the at least one frequency component.

### PRIORITY

This application claims the benefit under 35 U.S.C. §119(a) of a Korean patent application filed in the Korean Intellectual Property Office on Sep. 22, 2009 and assigned Serial No. 10-2009-0089411, the entire disclosure of which is hereby incorporated by reference.

### BACKGROUND OF THE INVENTION

1. Field of the Invention

The present invention relates to an apparatus and a method for recognizing a touch. More particularly, the present invention relates to an apparatus and a method for recognizing a touched position by measuring amplitudes or phases of a plurality of Radio Frequency (RF) signals generated during the touch.

2. Description of the Related Art

As mobile apparatuses such as mobile terminals, Portable Multimedia Players (PMP), and Play Station Portables (PSP) have developed, an input method has evolved from an existing mouse and a keypad, to a touch.

In a conventional touch recognition method, a sensor for detecting a touch is provided. The sensor has a single or multiple layers and includes patterns that recognize a relevant touch pressure. The sensor analyzes a portion of an entire part that corresponds to the recognized pressure, and transfers coordinates or other information corresponding to the portion to a host controller. Generally, the sensor may be one of two types, a Resistor (R) layer sensor or a Capacitance (C) sensor. The pattern type typically differs depending on the company manufacturing the sensor.

FIG. 1 is a view illustrating a Capacitance layer touch screen according to the conventional art.

Referring to FIG. 1, a single layer of touch electrodes 122a and 122b include triangle bar electrodes X11, X12, . . . , X52 that lie in an X-axis direction, and are repeatedly disposed in a Y-axis direction. In addition, the triangle bar electrodes X11, X12, . . . , X52 are disposed such that they face each other and are alternately engaged in the X-axis direction. Therefore, triangle bar electrodes facing each other, for example, X11 and X12 have inversely proportional ratios of a unit area along the X-axis direction.

A capacitance sensor chip 60 is installed on a Flexible Printed Circuit Board (FPCB) 50, detects a capacitance change caused by a contact a real ratio of a triangle electrode at each touch portion, determines a capacitance change value, and outputs position coordinates of a plane via an FPCB connector 70. A transparent conductor is used as touch electrodes 122a and 122b, and a metal conductor is used as the electrode connection line 40, so that wiring resistance is reduced. To protect the touch electrodes 122a and 122b, a transparent protection film 80 is added to an uppermost portion of the touch screen.

At a touch position A, positioned at 1 on the X-axis, an entire capacitance change includes 75% of X21 and 25% of X22. Also, at a touch position B, positioned at 2 on the X-axis, an entire touched capacitance change includes 50% of X11 and 50% of X12. Similarly, at a touch position C, an entire capacitance change includes 25% of X31 and 75% of X22. Here, since a Y-coordinate of an electrode Xxy is a position defined in advance, when a coordinate of an X axis is known, two-dimensional plane coordinates may be known.

As described above, since a coordinate on the X axis is known through an areal ratio of an electrode at a touch position and a Y coordinate is defined in advance in FIG. 1, a touch coordinate may be determined. A benefit of the sensor arrangement as illustrated in FIG. 1 is that is uses only a single layer of electrodes and therefore the light transmittance of the touch screen improves. In addition, since the number of electrode connection lines 40 connected to a capacitance sensor chip 60 is less than the number of electrode connection lines required for two layers of electrodes, the effective viewing area of the touch screen is increased. However, the sensor configuration of FIG. 1 has difficulty in determining a touch position when a multi-touch occurs.

FIG. 2 is a view illustrating a Resistance layer touch screen that can recognize a multi touch according to the conventional art.

Referring to FIG. 2, a lower transparent film 200 and an upper transparent film 300 are stacked on an insulation layer 100. A Y axis transparent resistive detection pattern 200a is formed on an upper surface of the lower transparent film 200, and an X axis transparent resistive detection pattern 300a is formed on a lower surface of the upper transparent film 300.

The transparent resistive detection patterns 200a and 300a are formed of an Indium-Tin-Oxide (ITO) layer including one layer divided into a plurality of stripes. The Y axis transparent resistive detection pattern 200a and the X axis transparent resistive detection pattern 300a are disposed such that they are perpendicular to each other to form a row and a column. A Y axis electrode 200b and an X axis electrode 300b are formed at both ends of the stripes of the transparent resistive detection patterns 200a and 300a. The electrodes 200b and 300b may be silver ink. In the Resistance layer touch screen of FIG. 2, a multi-touch is more easily detected as compared with the sensor of FIG. 1. However, because the Resistance layer sensor of FIG. 2 uses two layers of electrodes, light transmittance is reduced, as is the viewing area of the screen due to the increased area necessary for the electrode wiring.

In the conventional touch recognition sensors, a 1-point touch has no problem in recognition. However, a multi-point touch has many problems in recognition and extensibility is also problematic. That is, during a 2-point touch, a center portion of the 2 points may be erroneously recognized as the touch position. To address this problem, the number of layers needs to be increased. However, the additional layers reduce light transmittance and thus degrade the display capabilities of the touch screen.

Therefore, an improved apparatus and a method for recognizing a touch in order to process a multi touch that is easily extensible are required.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for recognizing a touch in order to process a multi touch.

Another aspect of the present invention is to provide an apparatus and a method for recognizing a touch using a Radio Frequency (RF) signal in order to operate and independently manage a host controller and an apparatus.

In accordance with an aspect of the present invention, an apparatus for recognizing a touch using a RF signal is provided. The apparatus includes an RF signal generator for, when one point is pressed in a touch panel, generating at least one RF signal corresponding to the one point, and a data processor for detecting at least one of an amplitude and a phase of each frequency component from the at least one RF signal, and for determining a touched position using the detected at least one of amplitude and phase information of the at least one frequency component.

In accordance with another aspect of the present invention, an apparatus for recognizing a touch using a RF signal is provided. The apparatus includes a Band Pass Filter (BPF) for filtering a frequency component of each relevant cell under an environment where a touch panel is divided into a plurality of cells, and a data processor for detecting at least one of a amplitude and a phase of a frequency of an RF signal corresponding to each cell with respect to the plurality of cells, for determining whether the detected at least one of the amplitude and the phase of the frequency of the RF signal meets a threshold, and for determining at least one cell where the detected at least one of the amplitude and the phase of the frequency of the RF signal meets the threshold as a touched position.

In accordance with still another aspect of the present invention, a method for recognizing a touch using a RF signal is provided. The method includes, when one point is pressed on a touch panel, generating at least one RF signal corresponding to the one point, detecting at least one of an amplitude and a phase of each frequency component from the at least one RF signal, and determining a touched position using the detected at least one of amplitude and phase information of the at least one frequency component.

In accordance with a further aspect of the present invention, a method for recognizing a touch using a RF signal is provided. The method includes filtering a frequency component of each relevant cell under an environment where a touch panel is divided into a plurality of cells, detecting an amplitude or a phase of a frequency of an RF signal corresponding to each cell with respect to the plurality of cells, determining whether the detected amplitude or phase of the RF signal meets a threshold, and determining at least one cell where the detected amplitude or phase of the frequency of the RF signal meets the threshold as a touched position.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a view illustrating a Capacitance layer touch screen according to the conventional art;

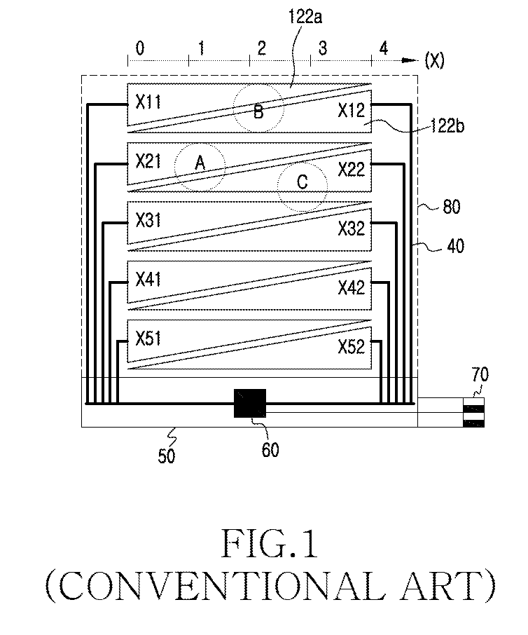

FIG. 2 is a view illustrating a Resistance layer touch screen that can recognize a multi touch according to the conventional art;

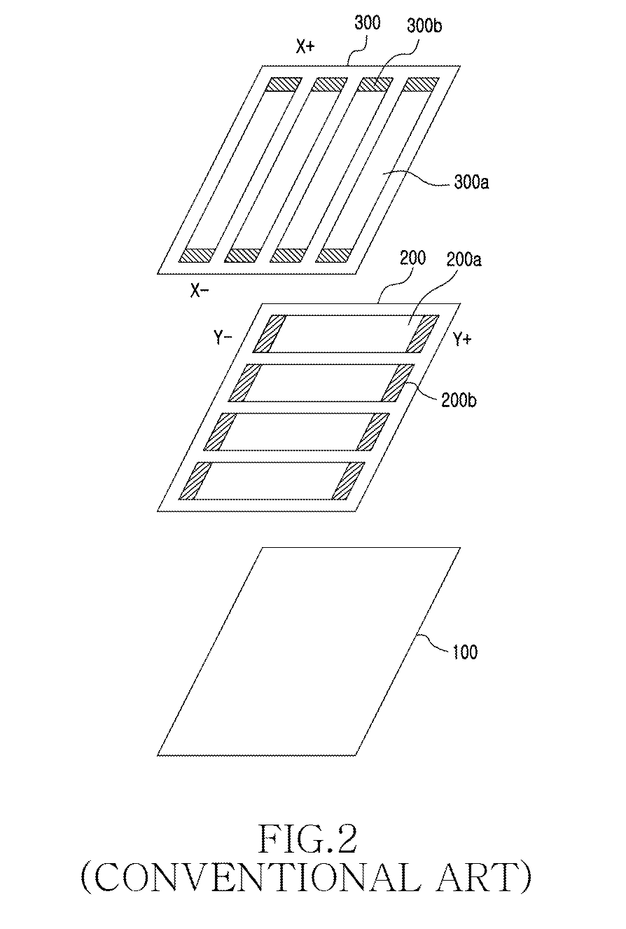

FIG. 3 is a block diagram illustrating an apparatus for recognizing a touch according to an exemplary embodiment of the present invention;

FIG. 4 is a block diagram illustrating an apparatus for recognizing a multi touch according to an exemplary embodiment of the present invention;

FIG. 5 is a flowchart of a method for recognizing a touch according to an exemplary embodiment of the present invention; and

FIG. 6 is a flowchart of a method for recognizing a multi touch according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component structure” includes reference to one or more of such surfaces.

Exemplary embodiments of the present invention provide an apparatus and a method for recognizing a touch using a Radio Frequency (RF) signal.

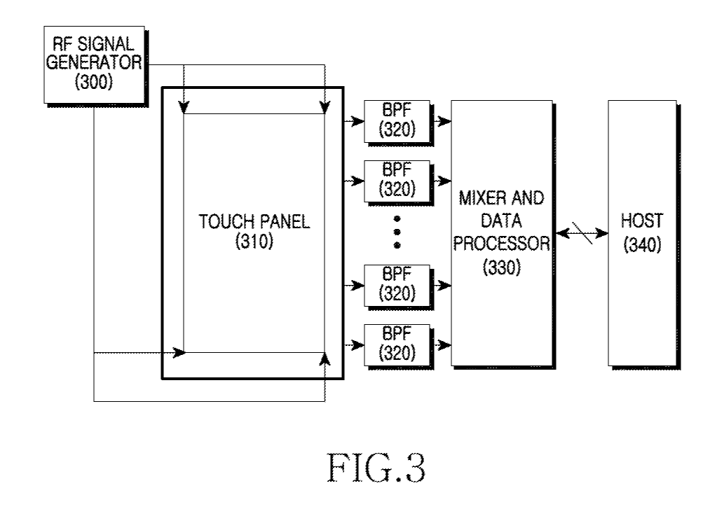

FIG. 3 is a block diagram illustrating an apparatus for recognizing a touch according to an exemplary embodiment of the present invention.

Referring to FIG. 3, the apparatus for recognizing a touch includes an RF signal generator 300, a touch panel 310, a plurality of Band Pass Filters (BPFs) 320, and a mixer and data processor 330.

When a certain position of the touch panel 310 is pressed by a user, the RF signal generator 300 generates at least one RF signal corresponding to the certain position under control of the touch panel 310. For example, the RF signal generator 300 outputs RF signals including frequency components f1, f2, f3, and f4 corresponding to the certain position. At this point, the RF signals including the frequency components f1, f2, f3, and f4 further include different amplitude or phase components depending on relevant positions, respectively. In other words, the position of the touch panel is determined using an amplitude component and/or a phase component of at least one RF signal. Therefore, when a certain position of the touch panel is pressed by a user, an RF signal corresponding thereto is generated.

The touch panel 310 includes an upper film and a lower film (or glass) where ITO is deposited, determines whether there is a contact input, detects a coordinate, and transmits a control signal. When a user inputs various data, for example, when a user simply contacts the touch panel 310, inputs a letter or draws a figure on the touch panel 310 using his finger or a pen, the touch panel 310 transmits a control signal corresponding to a relevant input coordinate value to the RF signal generator 300.

Each of the BPFs 320 blocks a frequency band except a relevant frequency from RF signals generated from the RF signal generator 300, and outputs the relevant frequency to the mixer and data processor 330.

The mixer and data processor 330 mixes each RF signal filtered by the plurality of BPFs 320 with a Local Oscillation (LO) frequency to convert each RF signal to a baseband signal. In addition, the mixer and data processor 330 detects an amplitude or a phase of an RF signal including a relevant frequency component to recognize a touched position using the detected amplitude or phase component information of the RF signal.

A host 340 (e.g., a mobile phone, a Portable Multimedia Player (PMP), a Play Station Portable (PSP), etc.) receives touch position information from the mixer and data processor 330 to perform a relevant operation.

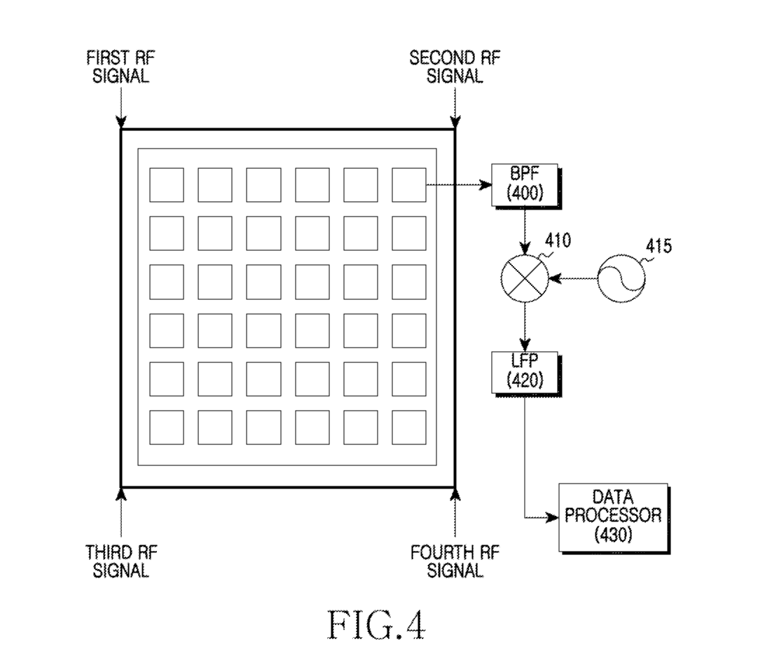

FIG. 4 is a block diagram illustrating an apparatus for recognizing a multi touch according to an exemplary embodiment of the present invention.

Referring to FIG. 4, four signals are used as basic RF signals for multi touch detection and the RF signals have different frequency components, respectively. For example, a left upper first RF signal includes a frequency component f1, a right upper second RF signal includes a frequency component f2, and lower third and fourth RF signals include frequency components f3 and f4, respectively.

The touch panel is divided into a plurality of cells wherein each cell is divided into amplitudes or phase components of the first RF signal, the second RF signal, the third RF signal, and the fourth RF signal. For example, left upper cells include a large first RF signal component and a small fourth RF signal component, and include a second RF signal component and a third RF signal component that are smaller than the first RF signal component but larger than the fourth RF signal component. In contrast, right lower cells include a large fourth RF signal component and a small first RF signal component, and include a second RF signal component and a third RF signal component that are smaller than the fourth RF signal component but larger than the first RF signal component.

That is, respective cells are discriminated by a ratio of the first RF signal component, the second RF signal component, the third RF signal component, and the fourth RF signal component.

A BPF 400 blocks a frequency band except a relevant frequency from RF signals generated from the respective cells, and a mixer 410 mixes a signal filtered by the BPF 400 with a LO frequency 415 to convert the signal into a baseband signal.

A Low-Frequency Power (LFP) amplifier 420 amplifies a baseband signal from the mixer 410 to provide the same to a data processor 430.

The data processor 430 detects an amplitude or phase of an RF signal including a relevant frequency component from RF signals generated from a relevant cell to recognize a touched position using the detected amplitude or phase information of the RF signal.

Though four RF signals for multi touch detection have been described as an example in FIG. 4, more RF signals may be used for increased accuracy of touch detection.

As described above, when the amplitude of each frequency in each cell is known, a currently touched portion may be known. This is done by considering a frequency characteristic of a touch panel. In an air interface, the amplitude of a signal reduces at a ratio of about 1/r² (r is a distance between two points). In this case, a touched position is determined by considering the characteristics of a dielectric and each device.

As illustrated in FIG. 4, a touched position is determined by comparing RF signal information with a threshold with consideration of the number of RF signals and the number of cells. The threshold is determined with consideration of touch sensitivity. Also, a multi touch may be detected through cell separation. Touch detection for cells may be performed one by one sequentially, or may be performed simultaneously and independently.

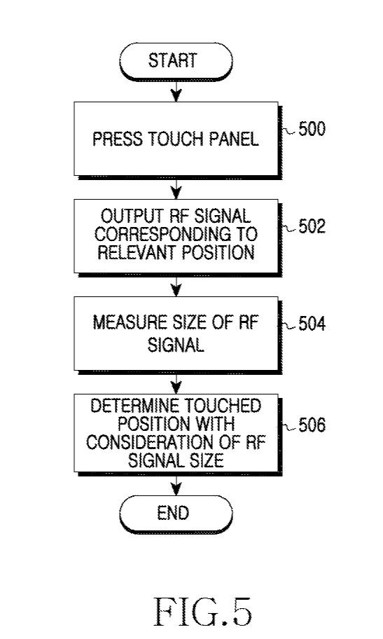

FIG. 5 is a flowchart of a method for recognizing a touch according to an exemplary embodiment of the present invention.

Referring to FIG. 5, when a touch panel is pressed by a user in step 500, an apparatus for recognizing a touch outputs one or more RF signals corresponding to the relevant position in step 502. The one or more RF signals have different frequency components.

The apparatus for recognizing a touch measures amplitudes of the one or more RF signals using a BPF in step 504. In an alternative exemplary implementation, instead of the amplitudes of the RF signals, the phases of the RF signals may be used.

The apparatus for recognizing a touch determines a touched position with consideration of the measured amplitude or phase of the RF signal in step 506. Arbitrary positions of the touch panel are discriminated using the amplitudes or phases of one or more RF signals.

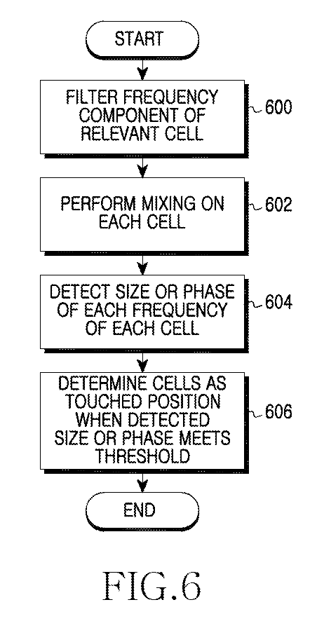

FIG. 6 is a flowchart of a method for recognizing a multi touch according to an exemplary embodiment of the present invention.

Referring to FIG. 6, an apparatus for recognizing a touch passes only a relevant frequency region of each cell and blocks other frequency regions in a touch panel divided into a plurality of cells in step 600. Here, the respective cells are discriminated by a plurality of RF signal components.

For example, in the case where the touch panel is divided into 64 cells, the apparatus for recognizing a touch filters only an RF signal component corresponding to a first cell and blocks frequency components of the remaining 63 cells using a first BPF. Likewise, the apparatus for recognizing a touch filters only an RF signal component corresponding to a second cell and blocks frequency components of the remaining 63 cells using a second BPF.

The apparatus for recognizing a touch mixes a filtered signal of each cell with an LO frequency to convert the signal into a baseband signal in step 602.

The apparatus for recognizing touch detects the amplitude or phase of each frequency component of a plurality of RF signals with respect to respective cells in step 604.

The apparatus for recognizing a touch determines one or more cell positions where the detected amplitude or phase of each frequency component of respective cells meets a threshold as a touched position in step 606.

While the invention has been shown and described with reference to certain exemplary embodiments thereof, it will be understood by those skilled in the art that various changes in form and details may be made therein without departing from the spirit and scope of the invention as defined by the appended claims and their equivalents.

As described above, multi touch recognition is possible even without an additional layer and controlling of sensitivity is easy as a touch is recognized using an RF signal. In addition, various touch recognition such as minute recognition of a touched position is possible through an increase in the number of RF signals or control of a cell interval.

What is claimed is:

1. An apparatus for recognizing a touch using a Radio Frequency (RF) signal, the apparatus comprising:
an RF signal generator for, when one point is pressed in a touch panel, generating at least one RF signal corresponding to the one point; and
a data processor for detecting at least one of an amplitude and a phase of each frequency component from the at least one RF signal, and for determining a touched position using the detected amplitude or phase information of the at least one frequency component.

2. The apparatus of claim 1, wherein the determining of the touched position comprises using at least one of amplitudes and phases of RF signals having different frequency components, respectively.

3. The apparatus of claim 1, further comprising:
a plurality of Band Pass Filters (BPFs) for band-passing the at least one RF signal; and
a mixer for mixing the band-passed signal with a Local Oscillation (LO) frequency.

4. The apparatus of claim 3, further comprising:
a Low Frequency Power (LFP) amplifier for amplifying a baseband signal received from the mixer and for providing the amplified signal to the data processor.

5. An apparatus for recognizing a touch using a Radio Frequency (RF) signal, the apparatus comprising:
a plurality of Band Pass Filters (BPFs) for filtering a frequency component of each relevant cell under an environment where a touch panel is divided into a plurality of cells; and
a data processor for detecting at least one of an amplitude and a phase of a frequency of an RF signal corresponding to each cell with respect to the plurality of cells, for determining whether the detected at least one of the amplitude and the phase of the frequency of the RF signal meets a threshold, and for determining at least one cell where the detected at least one of the amplitude and the phase of the frequency of the RF signal meets the threshold as a touched position.

6. The apparatus of claim 5, wherein the cells of the touch panel are discriminated by component ratios of a plurality of RF signals.

7. The apparatus of claim 6, wherein the cells of the touch panel are discriminated by the number of cells.

8. The apparatus of claim 5, wherein the RF signals are generated having different frequency components, and at least one of amplitudes and phases of the frequency components of the RF signals change depending on a touched position.

9. The apparatus of claim 5, wherein the threshold is determined according to touch sensitivity.

10. A method for recognizing a touch using a Radio Frequency (RF) signal, the method comprising:
when one point is pressed on a touch panel, generating at least one RF signal corresponding to the one point;
detecting at least one of an amplitude and a phase of each frequency component from the at least one RF signal; and
determining a touched position using the detected at least one of the amplitude and the phase information of the at least one frequency component.

11. The method of claim 10, wherein the determining of the touched position comprises using at least one of an amplitude and a phase of a plurality of RF signals having different frequency components, respectively.

12. The method of claim 10, further comprising:
band-passing the at least one RF signal; and
mixing the band-passed signal with a Local Oscillation (LO) frequency.

13. The method of claim 12, further comprising:
Low Frequency Power (LFP) amplifying the band-passed signal mixed with an LO frequency; and
providing the amplified signal to a data processor.

14. A method for recognizing a touch using a Radio Frequency (RF) signal, the method comprising:
filtering a frequency component of each relevant cell under an environment where a touch panel is divided into a plurality of cells;
detecting at least one of an amplitude and a phase of a frequency of an RF signal corresponding to each cell with respect to the plurality of cells;
determining whether the detected at least one of the amplitude and the phase of the RF signal meets a threshold; and
determining at least one cell where the detected at least one of the amplitude and the phase of the frequency of the RF signal meets the threshold as a touched position.

15. The method of claim 14, wherein the cells of the touch panel are discriminated by component ratios of a plurality of RF signals.

16. The method of claim 15, wherein the cells of the touch panel are discriminated by the number of cells.

17. The method of claim 14, wherein the RF signals are generated having different frequency components, and at least one of amplitudes and phases of the frequency components of the RF signals change depending on a touched position.

18. The method of claim 14, wherein the threshold is determined according to touch sensitivity.
